(19) United States
(12) Patent Application Publication
(10) Pub. No.: US 2017/0013432 A1
(43) Pub. Date: Jan. 12, 2017

(54) UE STATISTICS COLLECTION IN AN EMERGENCY AREA

(71) Applicant: TELEFONAKTIEBOLAGET LM ERICSSON (PUBL), Stockholm (SE)

(72) Inventors: Feng GUO, SHANGHAI (CN); Mei DONG, Shanghai (CN); Di LIU, SHANGHAI (CN); Nan ZHANG, GÖTEBORG (SE)

(73) Assignee: Telefonaktiebolaget LM Ericsson (publ), Stockholm (SE)

(21) Appl. No.: 15/113,261

(22) PCT Filed: Jan. 29, 2014
(86) PCT No.: PCT/CN2014/000136

§ 371 Date: Jul. 21, 2016

(51) Int. Cl. H04W 4/22; H04W 68/10; H04W 24/10; H04W 4/02; H04W 76/04; H04W 4/06; H04W 76/06

(52) U.S. Cl. CPC H04W 4/22; H04W 4/06; H04W 68/10; H04W 76/064; H04W 76/068; H04W 4/028; H04W 76/046; H04W 24/10; H04W 88/08

(57) ABSTRACT

Methods for collecting UE statistics in a specific area and the respective device and node are disclosed. The method in a first core network node comprises in response to receiving from a second core network node or an application functionality a command requesting UE statistics of idle UEs and connected UEs located in at least one base station covering at least a part of the specific area, transmitting at least one UE statistics request message to the at least one base station to trigger the base station to obtain UE statistics of idle UEs for the base station. The first core network node receives from the at least one base station, at least one UE statistics response message that includes the idle UE statistics, obtains UE statistics of connected UEs located in the at least one base station, and transmitting to, at least one of the second core network node or the application functionality, a report message including the UE statistics of the idle UEs and connected UEs located in the at least one base station.

### TECHNICAL FIELD

The present disclosure relates to UE statistics collection in an emergency area of a wireless communication network.

### BACKGROUND

Many emergency warning technologies have been developed in the past years. In case that an emergency, such as an earthquake, tsunami or fire disaster, is to happen or has happened, a warning message is expected to be broadcasted to people in the emergency area as soon as possible to reduce disaster damage. As the most popular and instant communication approach, the cell phone is considered the best way to notify the user of the warning information. In 3^{rd} Generation Partnership Project (3GPP) TS 36.413, the Emergency Area ID IE is used to indicate the area which has the emergency impact.

The warning message is important in damage reduction. However, in case that the emergency such as the disaster has happened and the damage has been done, it is also desired to have information of the people located in the emergency area for the purpose of rescue. For example, the number of people located in a building on fire is important for the firemen to take appropriate actions.

The information of the people can be derived from statistics of User Equipments (UEs) located in the emergency area. Unfortunately, the existing wireless communication networks do not have a mechanism to obtain the UE statistics accurately and efficiently. For example, a Mobility Management Entity (MME) may be aware of the number of UEs in the emergency area which are in the connected state, but not aware of the exact number of UEs which are in the idle state. A location reporting procedure is defined in 3GPP 36.413, which allows the MIME to request an eNodeB to report where a specific UE is currently located. However, the location reporting procedure can only obtain the location of one specific UE each time.

### SUMMARY

Therefore, it is an object of the present disclosure to solve at least one of the above-mentioned problems.

According to an aspect of the present disclosure, a method for a first core network node in a wireless communication network collecting UE statistics in a specific area is provided. The method comprises in response to receiving from a second core network node or an application functionality a command requesting UE statistics of idle UEs and connected UEs located in at least one base station covering at least a part of the specific area, transmitting at least one UE statistics request message to the at least one base station to trigger the base station to obtain UE statistics of idle UEs for the base station. The first core network node receives from the at least one base station, at least one UE statistics response message that includes the idle UE statistics, obtains LTE statistics of connected UEs located in the at least one base station, and transmitting to, at least one of the second core network node or the application functionality, a report message including the UE statistics of the idle UEs and connected UEs located in the at least one base station.

The statistics may include the number of UEs. The statistics may include UE location information and additionally include UE type information. The command may include network element location information on the specific area which indicates the at least one base station. The first core network node may include a MME and a Serving GPRS Support Node (SGSN). The second core network node may include a Policy and Charging Rules Functionality (PCRF) and a Gateway Mobile Location Centre (GMLC).

The at least one LTE statistics request message may include specific Radio Resource Control (RRC) paging messages to be broadcasted by the at least one base station, wherein each of the specific RRC paging messages is addressed to one specific idle UE to trigger the specific idle UE to establish RRC connections with the base station. The at least one UE statistics request message may include a general RRC paging message to be broadcasted by the at least one base station, wherein the general RRC paging message is not addressed to any specific idle LTE but to all idle UEs to trigger the idle UEs to establish RRC connections with the corresponding base station base station. The specific RRC paging message or general RRC paging message may comprise an indicator to indicate the idle UEs to release the RRC connections within a time period after establishment of the RRC connections respectively.

According to another aspect of the present disclosure, a method for a base station in a wireless communication network collecting UE statistics is provided. The method comprises receiving from a core network node at least one UE statistics request message. The base station broadcasts information corresponding to the at least one LTE statistics request message to idle UEs located in the base station to trigger the idle UEs to establish RRC connections with the base station, obtains the UE statistics of the idle UEs located in the base station from the RRC connections, and transmits to the core network node a UE statistics response message that includes the idle UE statistics.

The at least one UE statistics request message may include specific RRC paging messages each of which is addressed to one specific idle UE to trigger the specific idle UE to establish RRC connections with the base station, and the broadcasting may comprise broadcasting the specific RRC paging messages. The at least one UE statistics request message may include a general RRC paging message which is not addressed to any specific idle UE but to all idle UEs to trigger the idle UEs to establish RRC connections with the base station, and the broadcasting may comprise broadcasting the general RRC paging message. The specific RRC paging message or general RRC paging message may comprise an indicator to indicate the idle UEs to release the RRC connections within a time period after establishment of the RRC connections respectively.

According to a further aspect of the present disclosure, a method for a LTE in a wireless communication network is provided. The method comprises receiving in an idle state from a base station a UE statistics request message, and in response to the UE statistics request message, establishing a RRC connection with the base station.

The UE statistics request message may include a specific RRC paging message which is addressed to the UE to trigger the UE to establish a RRC connection with the base station. The UE statistics request message may include a general RRC paging message which is not addressed to any specific idle UE but to all idle UEs located in the base station to trigger the idle UEs to establish RRC connections with the base station. The specific RRC paging message or general RRC paging message may comprise an indicator to indicate the UE to release the RRC connection within a time period after establishment of the RRC connection.

According to a still further aspect of the present disclosure, a first core network node in a wireless communication network operable to collect UE statistics in a specific area is provided. The first core network node comprises a first interface adapted to communicate with a second core network node or an application functionality, and a second interface adapted to communicate with at least one base station covering at least a part of the specific area. The first core network node further comprises a controlling unit adapted to in response to receiving from the second core network node or the application functionality via the first interface a command requesting UE statistics of idle UEs and connected UEs located in the at least one base stations, transmit to, the at least one base station via the second interface, at least one UE statistics request message to trigger the base station to obtain UE statistics of idle UEs for the base station, receive from, the at least one base station via the second interface, at least one UE statistics response message that includes the idle UE statistics, obtain UE statistics of connected UEs located in the at least one base station, and transmit to, at least one of the second core network node or the application functionality via the first interface, a report message including the UE statistics of the idle UEs and connected UEs located in the at least one base station.

According to a still further aspect of the present disclosure, a base station in a wireless communication network operable to collect LTE statistics is provided. The base station comprises a first interface adapted to communicate with a core network node, and a second interface adapted to communicate with UEs located in the base station. The base station further comprises a controlling unit adapted to receive from, the core network node via the first interface, at least one UE statistics request message, broadcast via the second interface information corresponding to the at least one LTE statistics request message to idle UEs located in the base station to trigger the idle UEs to establish RRC connections with the base station, obtain the UE statistics of the idle UEs located in the base station from the RRC connections, and transmit to, the core network node via the first interface, a UE statistics response message that includes the idle UE statistics.

The at least one LIE statistics request message may include specific RRC paging messages each of which is addressed to one specific idle LIE to trigger the specific idle UE to establish RRC connections with the base station, and the controlling unit may be further adapted to broadcast the specific RRC paging messages. The at least one UE statistics request message may include a general RRC paging message which is not addressed to any specific idle UE but to all idle UEs to trigger the idle UEs to establish RRC connections with the base station, and the controlling unit may be further adapted to broadcast the general RRC paging message. The specific RRC paging message or general RRC paging message may comprise an indicator to indicate the idle UEs to release the RRC connections within a time period after establishment of the RRC connections respectively.

According to a still further aspect of the present disclosure, a UE in a wireless communication network is provided. The UE comprises an interface adapted to communicate with a base station and a controlling unit. The controlling unit is adapted to receive in an idle state from the base station a UE statistics request message via the interface, and in response to the UE statistics request message, establish a RRC connection with the base station.

By broadcasting UE statistics request message(s) such as RRC paging message(s) to idle UEs located in the emergency area and intentionally triggering the idle UEs to establish RRC connections, the statistics of the idle UEs and accordingly of all the UEs located in the emergency area may be accurately and efficiently collected.

### BRIEF DESCRIPTION OF THE DRAWINGS

The invention will be described in detail by reference to the following drawings, in which:

FIG. 1 illustrates a schematic view of a Long Term Evolution (LTE) network 100 including entities involved in the UE statistics collection;

FIG. 2 illustratively shows a signaling flow 200 of the UE statistics collection in a wireless communication network in accordance to an embodiment of the disclosure;

FIG. 3 illustratively shows a method 300 for a first core network node in a wireless communication network collecting UE statistics in a specific area in accordance with an embodiment of the disclosure;

FIG. 4 illustratively shows a method 400 for a base station in a wireless communication network collecting UE statistics in accordance with an embodiment of the disclosure;

FIG. 5 illustratively shows a method 500 for a UE in a wireless communication network in accordance with an embodiment of the disclosure; and

FIG. 6 illustratively shows a block diagram of a first core network node 610, a base station 620 and a UE 630 involved in the UE statistics collection in accordance with an embodiment of the disclosure.

### DETAILED DESCRIPTION

Embodiments of the present disclosure will be described more fully hereinafter with reference to the accompanying drawings, in which embodiments of the disclosure are shown. This invention may, however, be embodied in many different forms and should not be construed as limited to the embodiments set forth herein. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present disclosure is described below with reference to block diagrams and/or flowchart illustrations of methods, apparatus (systems) and/or computer program products according to embodiments of the disclosure. It is understood that blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Accordingly, the present disclosure may be embodied in hardware and/or in software (including firmware, resident software, micro-code, etc.). Furthermore, the present disclosure may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

Although the disclosure is described with reference to the LTE in the context, the skilled in the art should understand that the invention is not limited to this, but can indeed be applied to all existing and future wireless communication networks that support RRC connection establishment. Although specific terms are used here, such as UE and eNodeB, it should be understood that the invention is not limited to those specific terms but can be applied to all similar entities.

Embodiments of the disclosure will be described below with reference to the drawings.

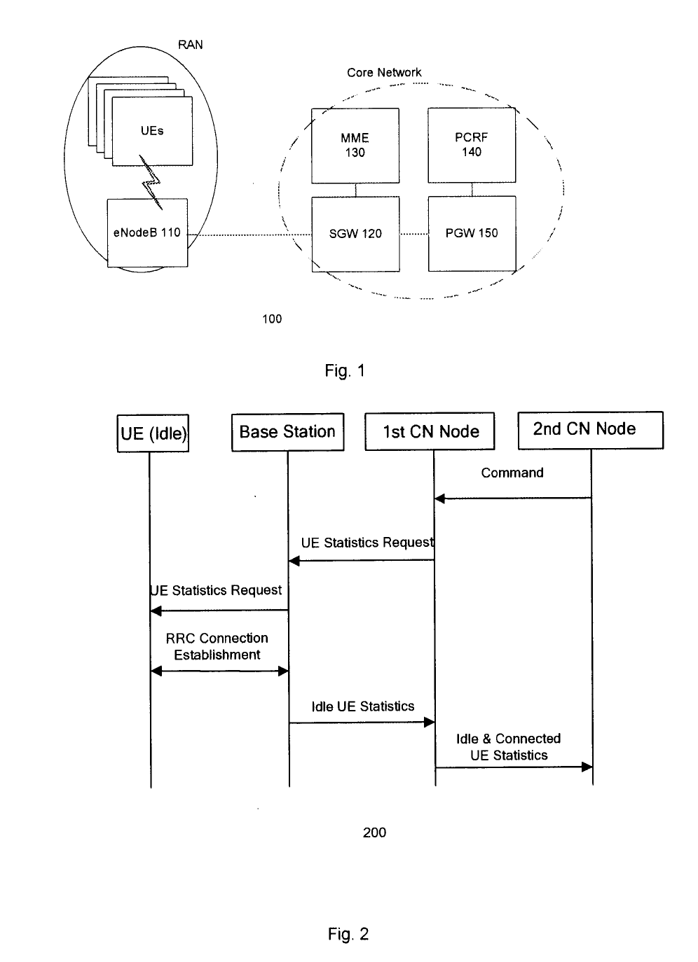

FIG. 1 illustrates a schematic view of a Long Term Evolution (LTE) network 100 including entities involved in the UE statistics collection.

The LTE network 100 includes a Radio Access Network (RAN, referred to as E-UTRAN in LTE) and a Core Network (CN, referred to as EPC in LTE). The eNodeB 110 is an element of the RAN which is capable to communicate with UEs located in its coverage. The Serving Gateway (SGW) 120, MME 130, PCRF 140, PDN Gateway (PGW) 150 are elements of the core network. The functions of these elements/nodes are defined in 3GPP specifications and will not be discussed in detail.

FIG. 2 illustratively shows a signaling flow 200 of the UE statistics collection in accordance to an embodiment of the disclosure.

In case that an emergency happens in a specific area, one or more wireless communication network operator whose service covers the area may be requested by, e.g. municipal administration, to provide statistics of UEs located in the area to facilitate rescue. As shown in FIG. 2, a command requesting UE statistics of all the UEs located in base stations covering at least a part of the specific area is transmitted to a first core network node. The first core network node may be, e.g. a MME or a SGSN. The command may come from a second core network node such as a PCRF or a GMLC, or from an application functionality that is accessible to e.g. the operator or municipal administration. The command includes location information on the specific area. The information may be represented by coverage of at least one base station, hereinafter referred to as network element location information. Depending on the area impacted by the emergency, the specific area may covered by one or more base station. For example, in case that a building is on fire, only statistics of UEs located in the cell covered by one base station, even by one sector, is needed. In contrast, in case that an earthquake happens, the impacted area is much larger and could correspond to coverage of base stations managed by one MME, base stations managed by more MMES or even the whole wireless communication network. Different granularity levels, such as Routing Area (RA), Tracking Area (TA), eNodeB or E-UTRAN Cell Global Identifier (ECGI), may be used in the command to indicate the scale of the interested area. Therefore it should be understood that the term “base station” as used herein may represent different level of RAN network elements, such as an eNodeB or a sector.

Generally, the location information on the specific area as received by the first core network is network element location information on the specific area which indicates the at least one base station. However it is possible that the location information from the second core network node or from an application functionality is not the network element location information, but geography location information represented by, e.g. latitude and longitude coordinates. In this case, the geography location information may be converted to the network element location information in advance by any core network element.

In response to receive the command, the first core network node, such as MME, transmits at least one UE statistics request message to the at least one base station to trigger the base station to obtain UE statistics of idle UEs for the base station. The UE statistics of connected UEs located in the at least one base station is available to the first core network node. It should be noted that there may be more than one core network node and more than one base station involved in the procedure, depending on the size of the specific area. For purpose of simplicity, FIG. 2 only shows the signalling between one first core network node and one base station.

The base station receives from the first core network node at least one LIE statistics request message, and broadcasts information corresponding to the UE statistics request message to idle UEs located in the base station to trigger the idle UEs to establish RRC connections with the base station. The information broadcasted by the base station may or may not have the same format as that of the UE statistics request message. The idle UEs, when receiving the broadcasted at least one UE statistics request message, establish the RRC connections with the base station. The procedure of RRC connection establishment is defined in the 3GPP specifications and will not be discussed in detail. During the RRC connection establishment with the idle UEs, the base station may obtain various statistics of these UEs from the RRC connections. For example, the base station may calculate the number of the idle UEs by counting the number of newly established RRC connections. The base station then transmits to the first core network node a UE statistics response message that includes the obtained idle UE statistics. The first core network node receives from the base station the UE statistics response message that includes the idle UE statistics. In case there is more than base station involved, the first core network node receives from all the involved base stations the UE statistics response messages respectively. The first core network node obtains UE statistics of connected UEs located in the at least one base station, and transmits to, the second core network node or the application functionality, a report message including the UE statistics of the idle UEs and connected UEs located in the at least one base station. The UE statistics in the specific area is thus accurately and efficiently collected and can be used for rescue.

In addition to the number of UEs, the UE statistics may include UE location information which can be used to locate the user during rescue. Additionally, the UE type information, such as Machine Type Communication (MTC) or Machine to Machine (M2M), may be included in the LIE statistics. Those MTC or M2M devices will not be counted in when calculating the total number of users. The various types of information may be combined in a table or a list and transmitted to the first core network node. The first core network may further process the UE statistics from the at least one base station (e.g. obtain a sum of the UE numbers located in different base stations) and report it to the second core network node or the application functionality.

The UE statistics request message may be any message that is capable of triggering the idle

UEs receiving the message to establish RRC connections with the base station. To minimize the impact to the existing 3GPP standard, it is proposed to reuse the RRC paging message as defined in the 3GPP specification. Two exemplary embodiments will be discussed hereinafter.

In one embodiment, the at least one UE statistics request message may be the standard RRC paging messages. Each RRC paging message, hereinafter referred to as specific RRC paging message, is addressed to one specific idle UE. In this case the first core network node, such as the MME, may have a record for the idle UEs and knows which base station is serving a specific UE, but however may not ascertain whether or not the idle UEs are indeed located in coverage of the base station or of the MIME, and can not obtain the accurate number of UEs, or the accurate location information of the UEs. The first core network node transmits to the at least one base station specific RRC paging messages and the at least one base station broadcasts the specific RRC paging messages over air interface. A specific idle UE monitors the specific RRC paging message on the paging occasions assigned to the UE. When the specific RRC paging message addressed to the specific idle UE is received, it establishes a RRC with the base station. In this embodiment, the standard RRC paging message does not need to be modified and the UE statistics collection procedure is transparent to the UE. The impact to the base station and the core network node is also minimized. However, a large number of RRC paging messages need to be transmitted and broadcasted, which will consume a considerable amount of signaling resources.

In another embodiment, the at least one UE statistics request message may be a newly defined RRC paging message, hereinafter referred to as general RRC paging message. The general RRC paging message is not addressed to any specific idle UE but to all idle UEs. The general RRC paging message may be derived by modifying the standard RRC paging message, e.g. by removing the specific idle UE address information contained in the standard RRC paging message or replacing it with a predefined value so that any idle UE that receives the message will recognize it. The first core network node transmits the same general RRC paging message to the at least one base station which in turn broadcasts the same general RRC paging message to the idle UEs. Each idle UE, when receiving the general RRC paging message, establishes a RRC with the base station. As compared with the preceding embodiment, the consumed signaling resources are greatly reduced which is especially important for the area where emergency has happened.

The RRC connections are intentionally established for purpose of UE statistics collection. To further reduce the resource consumption, the specific RRC paging message or general RRC paging message may comprise an indicator to indicate the idle UEs to release the RRC connections within a time period after establishment of the RRC connections respectively.

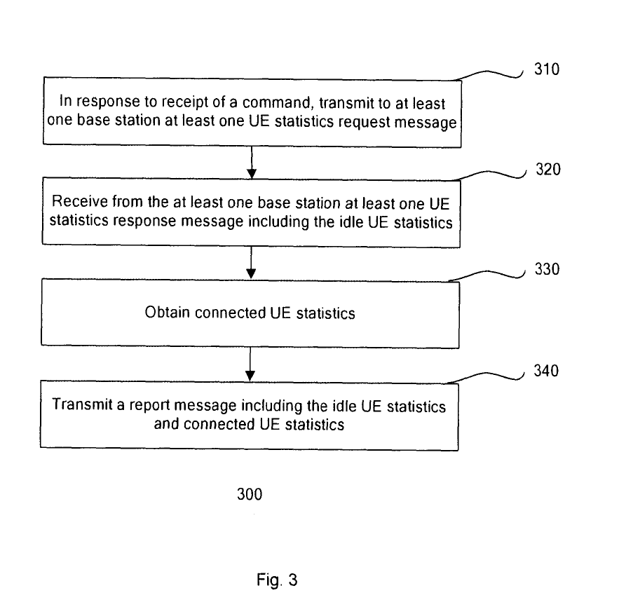

FIG. 3 illustratively shows a method 300 for a first core network node in a wireless communication network collecting UE statistics in a specific area in accordance with an embodiment of the disclosure.

At step 310, in response to receiving from a second core network node or an application functionality a command requesting UE statistics of idle UEs and connected UEs located in at least one base station covering at least a part of the specific area, the first core network node transmitting at least one UE statistics request message to the at least one base station to trigger the base station to obtain UE statistics of idle UEs for the base station. At step 320, the first core network node receives from the at least one base station, at least one UE statistics response message that includes the idle LTE statistics. The first core network node obtains at step 330 UE statistics of connected UEs located in the at least one base station, and transmits at step 340 to, at least one of the second core network node or the application functionality, a report message including the UE statistics of the idle UEs and connected UEs located in the at least one base station.

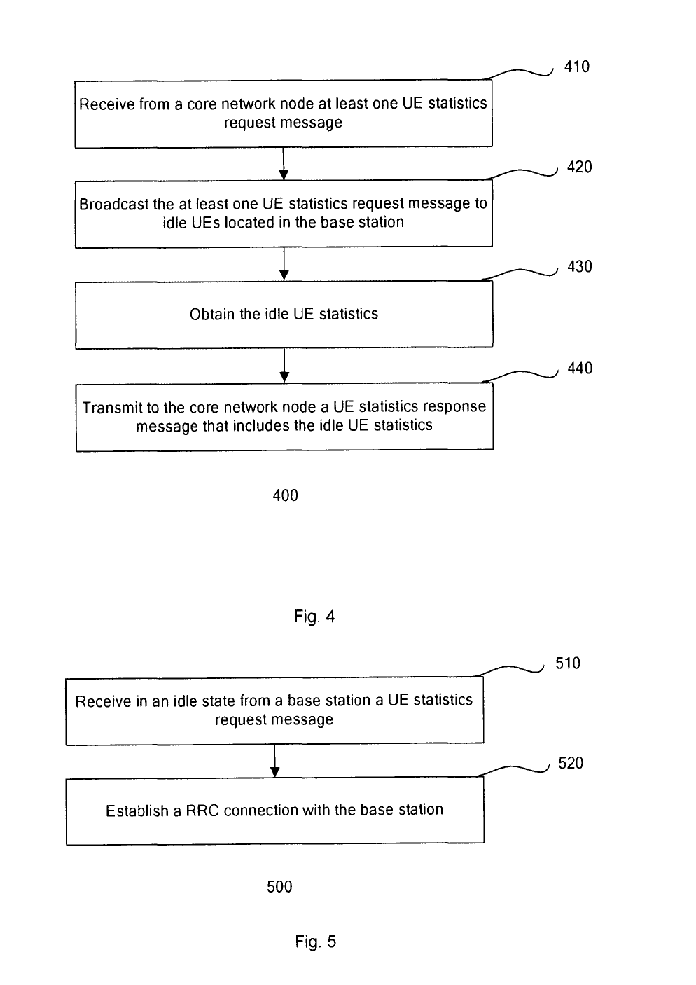

FIG. 4 illustratively shows a method 400 for a base station in a wireless communication network collecting UE statistics in accordance with an embodiment of the disclosure.

At step 410, the base station receives from a core network node at least one UE statistics request message. At step 420, it broadcasts information corresponding to the at least one UE statistics request message to idle UEs located in the base station to trigger the idle UEs to establish RRC connections with the base station. The broadcasting may include broadcasting the specific

RRC paging messages or the general RRC paging message. The base station obtains at step 430 the UE statistics of the idle UEs located in the base station from the RRC connections, and transmits to the core network node a UE statistics response message that includes the idle UE statistics.

FIG. 5 illustratively shows a method 500 for a UE in a wireless communication network in accordance with an embodiment of the disclosure.

At step 410, the LTE receives in an idle state from a base station a UE statistics request message. At step 420, in response to the UE statistics request message, the UE establishes a RRC connection with the base station.

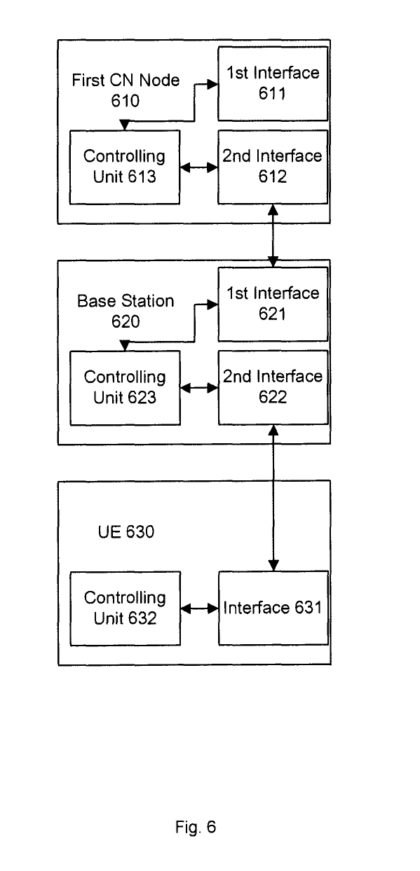

FIG. 6 illustratively shows a block diagram of a first core network node 610, a base station 620 and a UE 630 involved in the UE statistics collection in accordance with an embodiment of the disclosure.

The firs first core network node 610 comprises a first interface 611 adapted to communicate with a second core network node or an application functionality, a second interface 612 adapted to communicate with at least one base station 620 covering at least a part of the specific area, and a controlling unit 613. The controlling unit 613 is adapted to in response to receiving from a second core network node or an application functionality via the first interface 611 a command requesting UE statistics of idle UEs and connected UEs located in the at least one base station 620, transmit to, the at least one base station 620 via the second interface 612, at least one UE statistics request message to trigger the base station 620 to obtain UE statistics of idle UEs for the base station 620. The controlling unit 613 is further adapted to receive from, the at least one base station 620 via the second interface 612, at least one UE statistics response message that includes the idle UE statistics, obtain UE statistics of connected UEs located in the at least one base station 620, and transmit to, at least one of the second core network node or the application functionality via the first interface 611, a report message including the UE statistics of the idle UEs and connected UEs located in the at least one base station 620.

The base station 620 comprises a first interface 621 adapted to communicate with the core network node 610, and a second interface 622 adapted to communicate with UEs 620 located in the base station. The base station 620 further comprises a controlling unit 623 adapted to receive from, the core network node 610 via the first interface 621, at least one UE statistics request message, broadcast via the second interface 622 information corresponding to the at least one UE statistics request message to idle UEs located in the base station to trigger the idle UEs to establish RRC connections with the base station 620, obtain the UE statistics of the idle UEs located in the base station 620 from the RRC connections, and transmit to, the core network node 610 via the first interface 621, a UE statistics response message that includes the idle UE statistics. The controlling unit 623 may be further adapted to broadcast the specific RRC paging messages or the general RRC paging message.

The UE 630 comprises an interface 631 adapted to communicate with a base station 620 and a controlling unit 632. The controlling unit 632 is adapted to receive in an idle state from the base station 620 a UE statistics request message via the interface 631, and in response to the UE statistics request message, establish a RRC connection with the base station 620.

It should be noted that components in the core network node, base station and UE may be implemented by software or hardware or the combination thereof. For example, the controlling unit may comprise a processing unit, which may be provided on a single chip or a chip module and which may be any processor or computer device that performs operations based on program codes or instructions stored in a memory. Program codes are fetched from the memory and loaded into the processing unit in order to perform the steps described in connection with FIGS. 3 to 5. The controlling unit may share the same processing unit or memory with the node, base station or UE, or use separate hardware.

While the exemplary embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from its central scope. Therefore it is intended that the present invention is not be limited to the particular embodiment disclosed as the best mode contemplated for carrying out the present invention, but that the present invention include all embodiments falling within the scope of the appended claims.

1. A method for a first core network node in a wireless communication network collecting user equipment (UE) statistics in a specific area, the method comprising:
in response to receiving from one of a second core network node and an application functionality a command requesting UE statistics of idle UEs and connected UEs located in a cell of a base station covering at least a part of the specific area, transmitting a UE statistics request message to the base station to trigger the base station to obtain UE statistics of idle UEs for the base station;
receiving, from the base station, at least one UE statistics response message that includes the idle UE statistics;
obtaining UE statistics of connected UEs located in the cell of the base station; and
transmitting to, at least one of the second core network node and the application functionality, a report message including the UE statistics of the idle UEs and connected UEs located in the cell of the base station.

2. The method of claim 1, wherein the statistics includes one or more of: the number of UEs and UE location information.

3-4. (canceled)

5. The method of claim 1, wherein the command includes network element location information on the specific area which indicates the base station.

6. The method of claim 1, wherein
the UE statistics request message includes a first Radio Resource Control (RRC) paging message to be broadcasted by the base station and a second RRC paging message to be broadcasted b. base station, wherein the first RRC paging message is addressed to a first specific idle UE to trigger the first specific idle UE to establish an RRC connection with the base station and the second RRC paging message is addressed to a second specific idle UE to trigger the second specific idle UE to establish an RRC connection with the base station, or
the UE statistics request message includes a general RRC paging message to be broadcasted by the base station to trigger at least one or more idle UEs that receive the paging message to establish an RRC connection with the base station, wherein the general RRC paging message is not addressed to any specific idle UE.

7. (canceled)

8. The method of claim 6, wherein the specific RRC paging message or general RRC paging message comprises an indicator to indicate the idle UEs to release the RRC connections within a time period after establishment of the RRC connections respectively.

9. A method in a wireless communication network for collecting user equipment (UE) statistics, the method comprising:
receiving at a base station a UE statistics request message transmitted by a core network node;
broadcasting, by the base station, triggering information corresponding to the UE statistics request message trigger idle UEs to establish a Radio Resource Control (RRC) connection with the base station;
based on RRC connections established as a result of the broadcasting of the triggering information, obtaining UE statistics of the idle UEs; and
transmitting to the core network node a UE statistics response message that includes the obtained UE statistics.

10. The method of claim 9, wherein the statistics includes one or more of: the number of UEs and UE location information.

11-12. (canceled)

13. The method of claim 9, wherein:
the UE statistics request message includes specific RRC paging messages each of which is addressed to one specific idle UE to trigger the specific idle UE to establish RRC connections with the base station; and the broadcasting comprises broadcasting the specific RRC paging messages, or
the UE statistics request message includes a general RRC paging message to trigger at least one or more idle UEs to establish an RRC connection with the base station; and the broadcasting comprises broadcasting the general RRC paging message.

14. (canceled)

15. The method of claim 13, wherein the specific RRC paging message or general RRC paging message comprises an indicator to indicate the idle UEs to release the RRC connections within a time period after establishment of the RRC connections respectively.

16. A method for a user equipment (UE) in a wireless communication network, the method comprising:
the UE, while in an idle state, receiving from a base station a UE statistics request message; and
in response to the UE statistics request message, the UE establishing a Radio Resource Control (RRC) connection with the base station.

17. The method of claim 16, wherein
the UE statistics request message includes a specific RRC paging message which is addressed to the UE to trigger the UE to establish a RRC connection with the base station, or
the UE statistics request message includes a general RRC paging message which is not addressed to any specific idle UE.

18. (canceled)

19. The method of claim 17, wherein the specific RRC paging message or general RRC paging message comprises an indicator to indicate the UE to release the RRC connection within a time period after establishment of the RRC connection.

20. A first core network node in a wireless communication network operable to collect user equipment (UE) statistics in a specific area, the first core network node comprising:
a first interface adapted to communicate with a second core network node or an application functionality;
a second interface adapted to communicate with a base station covering at least a part of the specific area; and
a controlling unit adapted to:
in response to receiving from the second core network node or the application functionality via the first interface a command requesting UE statistics of idle UEs and connected UEs located in the base station, transmit to, the the base station via the second interface, a UE statistics request message to trigger the base station to obtain UE statistics of idle UEs for the base station,
receive from, the base station via the second interface, a UE statistics response message that includes the idle UE statistics,
obtain UE statistics of connected UEs located in the base station, and
transmit to, at least one of the second core network node or the application functionality via the first interface, a report message including the UE statistics of the idle UEs and connected UEs located in the base station.

21. The first core network node of claim 20, wherein the statistics includes one or more of the number of UEs and UE location information.

22. (canceled)

23. The first core network node of claim 20, wherein the statistics includes UE type information and UE location information.

24. The first core network node of claim 20, wherein the command includes network element location information on the specific area which indicates the base station.

25. The first core network node of claim 20, wherein the at UE statistics request message includes specific Radio Resource Control (RRC) paging messages to be broadcasted by the base station, wherein each of the specific RRC paging messages is addressed to one specific idle UE to trigger the specific idle UE to establish RRC connections with the base station, or
the UE statistics request message includes a general RRC paging message to be broadcasted b the base station to trigger the idle UEs to establish RRC connections with the base station base station, wherein the general RRC paging message is not addressed to any specific idle UE.

26. (canceled)

27. The first core network node of claim 25, wherein the specific RRC paging message or general RRC paging message comprises an indicator to indicate the idle UEs to release the RRC connections within a time period after establishment of the RRC connections respectively.

28. A base station in a wireless communication network operable to collect user equipment (UE) statistics, the base station comprising:
a first interface adapted to communicate with a core network node;
a second interface adapted to communicate with UEs; and
a controlling unit adapted to:
receive from, the core network node via the first interface, a UE statistics request message,
broadcast via the second interface information corresponding to the UE statistics request message to idle UEs to trigger the idle UEs to establish Radio Resource Control (RRC) connections with the base station,
obtain the UE statistics of the idle UEs from the RRC connections, and
transmit to, the core network node via the first interface, a UE statistics response message that includes the idle UE statistics.

29. The base station of claim 28, wherein the statistics includes one or more of the number of UEs and UE location information.

30. (canceled)

31. The base station of claim 28, wherein the statistics includes one or more of UE type information and UE location information.

32. The base station of claim 28, wherein:
the UE statistics request message includes specific RRC paging messages each of which is addressed to one specific idle UE to trigger the specific idle UE to establish an RRC connection with the base station; and the controlling unit is further adapted to broadcast the specific RRC paging messages, or
the UE statistics request message includes a general RHO paging message to trigger idle UEs to establish RRC connections with the base station, wherein the general RRC paging message is not addressed to an specific idle UE; and the controlling unit is further adapted to broadcast the general RRC paging message.

33. (canceled)

34. The base station of claim 32, wherein the specific RRC paging message or general RRC paging message comprises an indicator to indicate the idle UEs to release the RRC connections within a time period after establishment of the RRC connections respectively.

35. A user equipment (UE) in a wireless communication network, the UE comprising:
an interface operable to receive a UE statistics request message transmitted by a base station while the UE is in an idle mode; and
a controller configured to:
in response to the UE statistics request message, establish a Radio Resource Control (RRC) connection with the base station.

36. The UE of claim 35, wherein
the UE statistics request message includes a specific RRC paging message which is addressed to the UE to trigger the UE to establish a RRC connection with the base station, or
the UE statistics request message includes a general RRC paging message to trigger idle UEs to establish RRC connections with the base station, wherein the general RRC paging message is not addressed to any specific idle UE.

37. (canceled)

38. The UE of claim 36, wherein the specific RRC paging message or general RRC paging message comprises an indicator to indicate the UE to release the RRC connection within a time period after establishment of the RRC connection.
